(19) United States
(12) Patent Application Publication
(10) Pub. No.: US 2010/0286845 A1
(43) Pub. Date: Nov. 11, 2010

(54) FAIL-SAFE SYSTEM FOR AUTONOMOUS VEHICLE

(76) Inventors: Andrew Karl Wilhelm Rekow, Cedar Falls, IA (US); Joseph Paul Kearney, Cedar Falls, IA (US)

Correspondence Address: DEERE & COMPANY, ONE JOHN DEERE PLACE, MOLINE, IL, 61265, US

(21) Appl. No.: 12/463,674

(22) Filed: May 11, 2009

(51) Int. Cl. G06F 19/00

(52) U.S. Cl. 701/2

(57) ABSTRACT

A fail-safe system is provided for an autonomous vehicle. The vehicle has a source of electrical power and electrical loads. The fail-safe system includes an operator controlled remote unit, a wireless transmitter connected to the remote unit for transmitting a wireless keep alive signal, a wireless receiver mounted on the vehicle for receiving the keep alive signal and a fail-safe unit connected to the receiver. The fail-safe unit includes first and second processing units, both connected to each other, to the receiver and to relay units which are operable to connect and disconnect the source of electrical power from the electrical loads in response to a signal from one of the processing units. Both processing units are operable to open their respective relay units and shut down all vehicle operations in response to a variety of fault conditions, including loss of the keep alive signal from the remote unit.

### FIELD OF THE INVENTION

The present invention relates to a fail-safe system for autonomous vehicle.

### BACKGROUND OF THE INVENTION

Unmanned or autonomous vehicles are being developed in order to avoid the disadvantages of manned vehicles, such as labor costs of drivers, accidents caused by inattentive, intoxicated or otherwise impaired drivers, and inaccuracies in execution of work tasks caused by variance between drivers, human limitations or other human factors. Such autonomous vehicles are being developed which will communicate with a remote operator controlled control unit. It has been proposed to provide such a remote unit with a “kill switch” or an emergency stop button. There is a need for a fail-safe system which will stop an autonomous vehicle and all its functions when an operator presses such an emergency stop button, with 100% assurance.

### SUMMARY OF THE INVENTION

Accordingly, an object of this invention is to provide a fail-safe system which will stop an autonomous vehicle and all its functions when an operator presses an emergency stop button on a remote control unit.

Another object of this invention is to provide such a fail-safe system which will stop an autonomous vehicle and all its functions under a variety of fault or failure conditions.

These and other objects are achieved by the present invention, wherein a fail-safe system is provided for an autonomous vehicle. The vehicle has a source of electrical power and electrical loads. The fail-safe system includes an operator controlled remote unit, a wireless transmitter connected to the remote unit for transmitting a wireless keep alive signal, a wireless receiver mounted on the vehicle for receiving the keep alive signal and a fail-safe unit connected to the receiver. The fail-safe unit includes first and second processing units, both connected to each other, to the receiver and to relay units which are operable to connect and disconnect the source of electrical power from the electrical loads in response to a signal from one of the processing units. Both processing units are operable to open their respective relay units in response to loss of the keep alive signal. Both processing units are operable to open their respective relay units in response to a shutdown signal generated by the remote unit. Each of the processing units is operable to open its respective relay units in response to loss of a heartbeat signal from the other processing unit. Feedback lines are connected from an output of each of the relay units to an input of both of the processing units. The processing units open their relay units in response to loss of power on the feedback line. Monitoring lines are connected from each relay drive line and to an input of the other processing unit. In the event of a relay sticking closed, the processing unit associated with another relay unit can initiate a shutdown. In the event that the processing units disagree about what a status of a relay drive line should be, the processing unit associated with the other relay unit can initiate a shutdown.

### BRIEF DESCRIPTION OF THE DRAWINGS

FIG. 1 is a simplified schematic representation of an autonomous vehicle which is in communication with a wireless remote control unit; and

FIG. 2 is schematic diagram of a fail-safe system which is part of the autonomous vehicle.

### DESCRIPTION OF THE PREFERRED EMBODIMENT

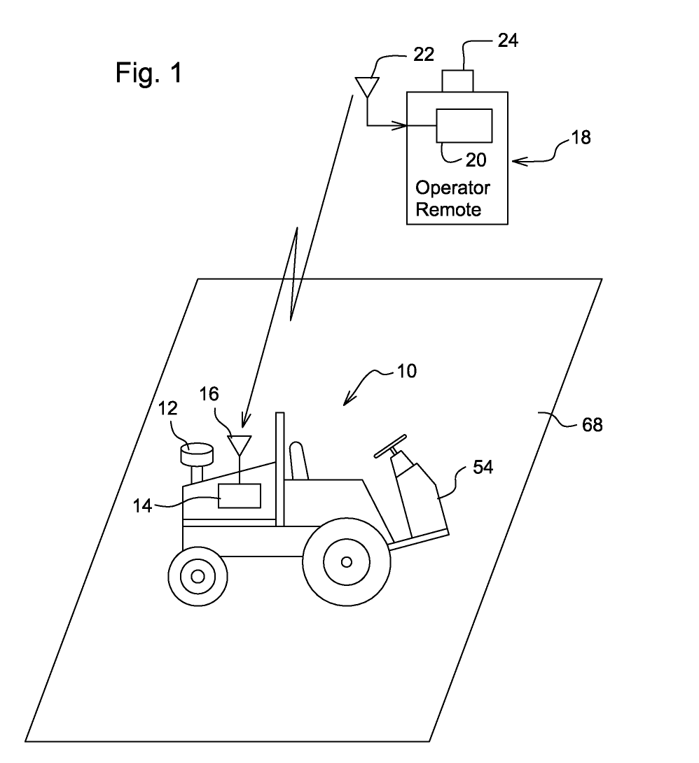

Referring to FIG. 1, an unmanned or autonomous vehicle 10 includes a positioning receiver 12, such as a GPS receiver, and a control unit (not shown) which controls the vehicle in response to the GPS receiver and path planning software (not shown). The vehicle 10 also includes a wireless receiver 14 and an antenna 16 which receives wireless signals from an operator controlled remote unit 18. Remote unit 18 includes an RF transmitter 20, an antenna 22, and a kill-switch, such as a pushbutton 24.

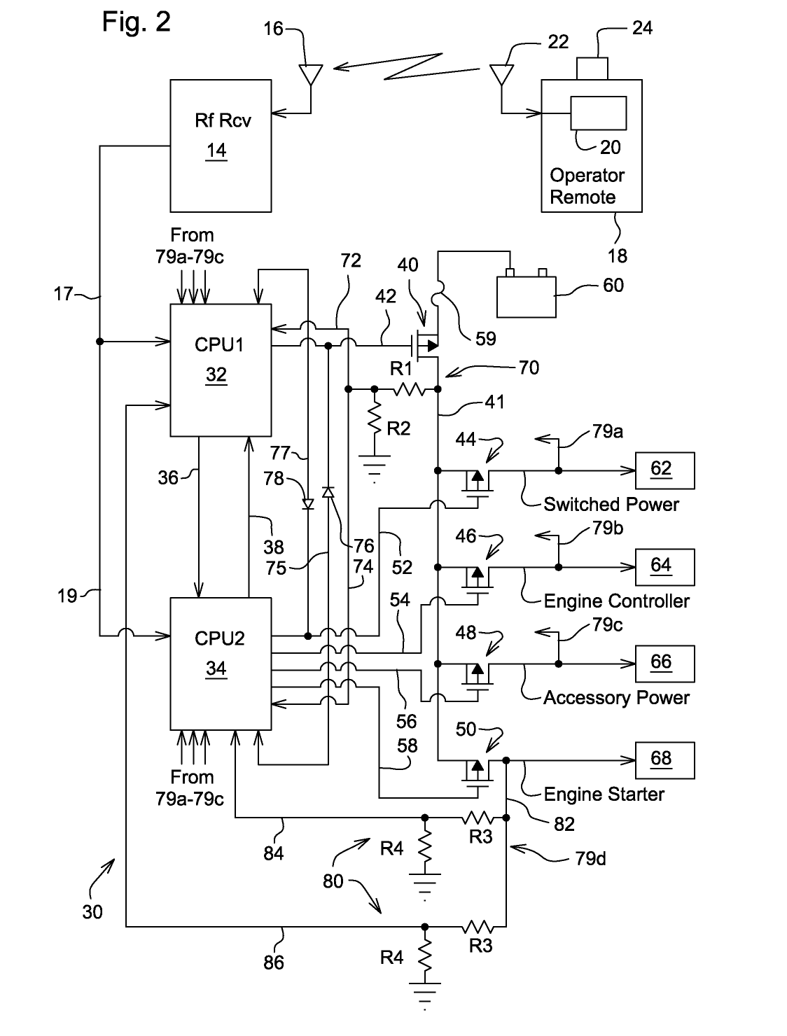

Referring now to FIG. 2, the receiver 14 is connected to fail-safe control unit 30. Control unit 30 includes first and second central processing units (CPU) 32 and 34, both of which receive a keep alive code from the receiver 14, as long as receiver 14 is receiving signals from the remote unit 18. First CPU 32 sends a periodic heartbeat signal over line 36 to second CPU 34. Second CPU 34 sends a periodic heartbeat signal over line 38 to first CPU 32. The heartbeat signal may be a simple signal which toggling between high and low, or it could be a more complex transfer of digital data codes.

First CPU 32 controls a relay 40 via relay drive line 42. Second CPU 32 control relays 44, 46, 48 and 50 via relay drive lines 52, 54, 56 and 58, respectively. Relay 40 is connected in series with a fuse 59 between a source of vehicle electrical power 60, such as a battery or alternator, and one side of each of the relays 44-50. Relays 44-50 are connected to relay 40 by line 41. Each relay 44-50 is also connected by a power line to a separate electrical load or circuit 62-68. For example, circuit 62 could be a switched power electrical load. Circuit 64 could be an engine controller. Circuit 66 could be accessory circuits or loads. Circuit 68 could be an engine starter. Removal of power from these circuits results in an emergency shutdown of the vehicle 10.

Feedback signals are transmitted from line 41 to both CPUs 32 and 34 by a resistor bridge 70 (resistors R1 and R2) and lines 72 and 74. Optionally, a monitoring line 75 with a diode 76 is connected between line 42 and CPU 34, and a monitoring line 77 with a diode 78 is connected between line 52 and CPU 32. Additional monitoring lines (not shown) may be connected between each of lines 54-58 and CPU 32, and diodes (not shown) may be similarly placed in these additional monitoring lines. Such diodes allow a diagnosis of whether a command is bad or a relay is bad, and ensure that a failed CPU cannot erroneously activate a relay.

Feedback signals are transmitted from the output of relay 50 to both CPUs 32 and 34 by a feedback circuit 79d which includes a resistor bridge 80 for each CPU (resistors R3 and R4) and lines 82, 84 and 86. Similar feedback signals are also preferably transmitted from the output of relays 44, 46 and 48 via similar feedback circuits 79a, 79b and 79c to respective inputs of both CPUs 32 and 34. Feedback circuits, such as feedback circuit 79a-d, are used for relay diagnostics to detect a “stuck” relay. These circuits include high impedance resistors R3 for protection in order to assure that the CPUs or relays cannot be powered through these feedback circuits, and to insure that neither CPU can influence the other CPU's reading of the output.

CPUs 32 and 34 each control their own relay or relays. Either CPU 32 or 34 can remove power from the vehicle operational systems. The CPUs 32 and 34 are programmed to control the relays in response to various conditions as follows:

Both CPUs 32 and 34 will shut down all their respective relays in response to the loss of valid data or the keep alive code from the remote unit 18. Both CPUs 32 and 34 will also shut down all their respective relays in response to a kill signal received from the remote unit in response to an operator pushing the kill switch button 24.

Each CPU 32 and 34 monitors the heartbeat signal generated by the other CPU. Each CPU 32 or 34 can initiate a shutdown through the other CPU when the first CPU fails to receive a heartbeat signal from the other CPU. For example, CPU 32 can shut down relay 40 if it fails to receive a heartbeat signal via line 38. Also, CPU 32 can command a shutdown through CPU 34 through line 36 if CPU 32 attempts but fails to shut down relay 40.

Each CPU 32 and 34 monitors the relay drive line connected between the other CPU and is corresponding relay. The monitoring lines 75 and 77 are protected by diodes 76 and 78 to prevent a short circuit or failure in one CPU from being able to drive the relay controlled by the other CPU. Thus, in the event of a relay sticking closed, the other CPU can initiate a shutdown. Also, in the event that the CPUs disagree about what a status of a relay drive line should be, the CPU associated with the other relay unit can initiate a shutdown.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

We claim:

1. A fail-safe system for an autonomous vehicle, the vehicle having a source of electrical power and an electrical load, the fail-safe system comprising:
an operator control unit remote from the vehicle;
a wireless transmitter connected to the operator control unit for transmitting a wireless keep alive signal;
a wireless receiver mounted on the vehicle for receiving the keep alive signal;
a fail-safe unit connected to the receiver, the fail-safe unit comprising:
a first processing unit connected to the receiver and connected to a first relay unit, the first relay unit being operable to connect and disconnect the source of electrical power from the electrical load in response to a signal from the first processing unit;
a second processing unit connected to the receiver, connected to a second relay unit and connected to the first processing unit, the receiver communicating the keep alive signal from the transmitter to the first and second processing units and,
the second relay unit being operable to connect and disconnect the source of electrical power from the electrical load in response to a signal from the second processing unit, both processing units being operable to open their respective relay units in response to loss of the keep alive signal.

2. The fail-safe system of claim 1, wherein:
both processing units are operable to open their respective relay units in response to a shutdown signal generated by the remote operator control unit.

3. The fail-safe system of claim 1, wherein:
each of the processing units is operable to open its respective relay units in response to loss of the heartbeat signal from the other processing unit.

4. The fail-safe system of claim 1, further comprising:
a feedback line connected from an output of one of the relay units to an input of both of the processing units, said processing units opening their relay units in response to loss of power on the feedback line.

5. The fail-safe system of claim 1, further comprising:
a plurality of feedback lines, each feedback line being connected from an output of one of the relay units to an input of both of the processing units, said processing units opening their relay units in response to loss of power on any of the feedback lines.

6. The fail-safe system of claim 1, wherein:
each of the processing units and monitors, via a monitoring line, a relay drive line connected between the other processing unit and its corresponding relay; and
in the event of a relay sticking closed, the processing unit associated with the other relay unit can initiate a shutdown.

7. The fail-safe system of claim 6, wherein:
each of the monitoring lines and is protected by a diode to prevent a short circuit or failure in one processing unit from being able to drive the relay controlled by the other processing unit.

8. The fail-safe system of claim 1, wherein:
each of the processing units and monitors, via a monitoring line, a relay drive line connected between the other processing unit and its corresponding relay; and
in the event that the processing units disagree about what a status of a relay drive line should be, the processing unit associated with the other relay unit can initiate a shutdown.
